(19) United States
(12) Patent Application Publication
(10) Pub. No.: US 2013/0204653 A1
(43) Pub. Date: Aug. 8, 2013

(54) CONFLICTING MEETING SCHEDULER

(71) Applicants: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(72) Inventors: Lorraine M. Herger, Port Chester, NY (US); Neal M. Keller, Pleasantville, NY (US); Matthew A. McCarthy, Holly Springs, NC (US); Clifford A. Pickover, Yorktown Heights, NY (US)

(73) Assignee: International Business Machines Corporation, Armonk, NY (US)

(21) Appl. No.: 13/364,318

(22) Filed: Feb. 2, 2012

(51) Int. Cl. G06Q 10/10

(52) U.S. Cl. 705/7.19

(57) ABSTRACT

A system and method for scheduling meetings at conflicting times. The method includes receiving from a meeting requestor a request to schedule a proposed meeting at a time interval. The method also includes determining that the time interval includes a conflicting meeting in an electronic calendar of at least one proposed meeting invitee. The method further includes automatically calculating by a computer processor a free-time probability value for the conflicting meeting based on at least one non-temporal attribute of the conflicting meeting or the proposed meeting. Additionally, the method includes automatically scheduling the proposed meeting if the free-time probability value is beyond a free-time probability threshold.

### BACKGROUND

This invention relates to scheduling meetings, and more particularly to a system and method for scheduling meetings at conflicting times.

In traditional electronic calendars, time intervals are often either “free” or “not-free.” A meeting may be scheduled on a user's electronic calendar if the user's time interval for the proposed meeting time is free and a meeting may not be scheduled if the user's time interval is not-free. This process is sometimes ineffective because it ignores the varying degrees of importance of previously scheduled meetings on the user's calendar.

### BRIEF SUMMARY

Accordingly, one example aspect of the present invention is a method of scheduling meetings at conflicting times. The method includes receiving from a meeting requestor a request to schedule a proposed meeting at a time interval. The method also includes determining that the time interval includes a conflicting meeting in an electronic calendar of at least one proposed meeting invitee. The method further includes automatically calculating by a computer processor a free-time probability value for the conflicting meeting based on at least one non-temporal attribute of the conflicting meeting or the proposed meeting. Additionally, the method includes automatically scheduling the proposed meeting if the free-time probability value is beyond a free-time probability threshold.

Another example of the present invention is a system for scheduling meetings at conflicting times. The system includes a computer processor configured to receive from a meeting requestor a request to schedule a proposed meeting at a time interval. The computer processor is further configured to determine that the time interval includes a conflicting meeting in an electronic calendar of at least one proposed meeting invitee. Additionally, the computer processor is configured to calculate a free-time probability value for the conflicting meeting based on at least one non-temporal attribute of the conflicting meeting or the proposed meeting. The computer processor is also configured to schedule the proposed meeting if the free-time probability value is beyond a free-time probability value threshold.

Yet another example of the present invention is a computer readable medium encoding instructions for performing a method of scheduling meetings at conflicting times. The method includes receiving from a meeting requestor a request to schedule a proposed meeting at a time interval. The method also includes determining that the time interval includes a conflicting meeting in an electronic calendar of at least one proposed meeting invitee. The method further includes automatically calculating by a computer processor a free-time probability value for the conflicting meeting based on at least one non-temporal attribute of the conflicting meeting or the proposed meeting. Additionally, the method includes automatically scheduling the proposed meeting if the free-time probability value is beyond a free-time probability threshold.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a method of scheduling meetings at conflicting times in accordance with one embodiment of the invention.

FIG. 2 shows a system for scheduling meeting at conflicting times according to one embodiment of the present invention.

FIG. 3 shows a computer-readable medium encoding instructions for performing a method for scheduling meetings at conflicting times according to one embodiment of the present invention.

### DETAILED DESCRIPTION

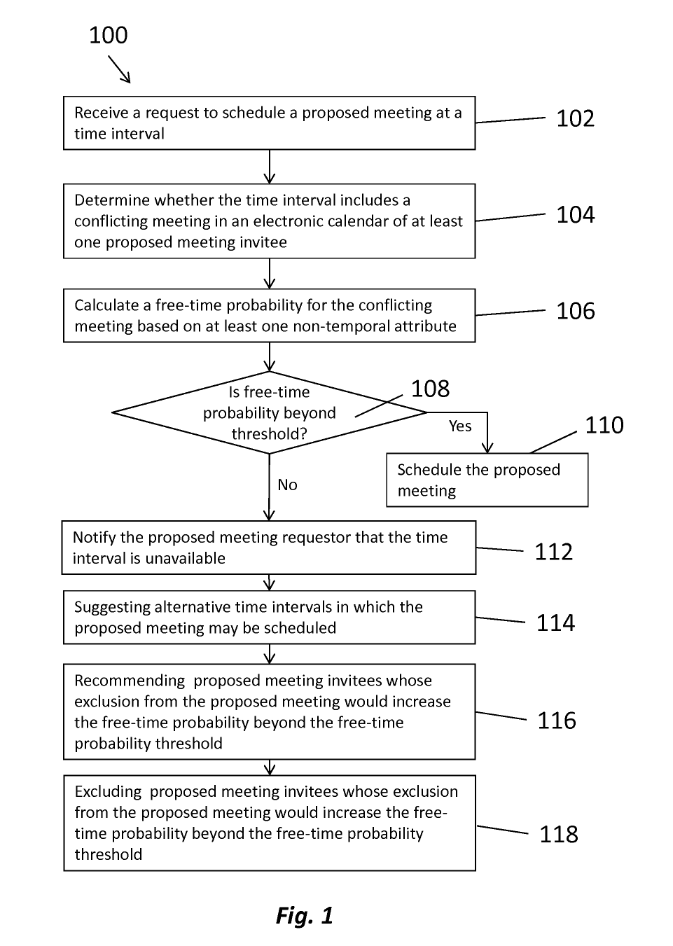

The present invention is described with reference to embodiments of the invention. Throughout the description of the invention reference is made to FIGS. 1-3. When referring to the figures, like structures and elements shown throughout are indicated with like reference numerals.

FIG. 1 shows a method of scheduling meetings at conflicting times according to one embodiment of the present invention. The method includes a receiving step 102. During receiving step 102, a request is received from a meeting requestor to schedule a proposed meeting at a time interval. After receiving step 102 is completed, the method continues to conflicting meeting determination step 104.

At conflicting meeting determination step 104, it is automatically determined whether the time interval includes a conflicting meeting in an electronic calendar of at least one proposed meeting invitee. If the proposed meeting does not conflict with another scheduled meeting, the proposed meeting is scheduled according to conventional techniques. However, if the proposed meeting does conflict with another meeting (referred to herein as a conflicting meeting), the method continues to free-time probability value calculation step 106.

At free-time probability value calculation step 106, a computer processor automatically calculates a free-time probability value for the conflicting meeting based on at least one non-temporal attribute of the conflicting meeting or the proposed meeting. The non-temporal attributes used to calculate the free-time probability value are discussed in more detail below. After free-time probability value calculation 106 is completed, the method continues to determining step 108.

At determining step 108, the free-time probability value is compared to a free-time probability value threshold. If the free-time probability value is beyond a free-time probability value threshold, the process proceeds to scheduling step 110, where the proposed meeting is automatically scheduled. On the other hand, if the free-time probability value is not beyond the free-time probability value threshold, the process continues to notification step 112. At notification step 112, the proposed meeting requestor is automatically informed that the time interval is unavailable if the free-time probability value is within free-time probability threshold. After notification step 112 is completed, the method continues to alternative time interval suggestion step 114.

At alternative time interval suggestion step 114, at least one alternative time interval in which the proposed meeting may be scheduled is suggested to the proposed meeting requestor. After alternative time interval suggestion step 114 is completed, the method continues to proposed meeting invitee exclusion step 116.

At proposed meeting invitee exclusion recommendation step 116, at least one proposed meeting invitee whose exclusion from the proposed meeting invitees would increase the free-time probability beyond the free-time probability threshold is recommended for exclusion. After proposed meeting invitee exclusion recommendation step 116 is completed, the method continues to proposed meeting invitee automatic exclusion step 118.

At proposed meeting invitee automatic exclusion step 118, at least one proposed meeting invitee whose exclusion from the proposed meeting invitees would increase the free-time probability beyond the free-time probability threshold is automatically excluded.

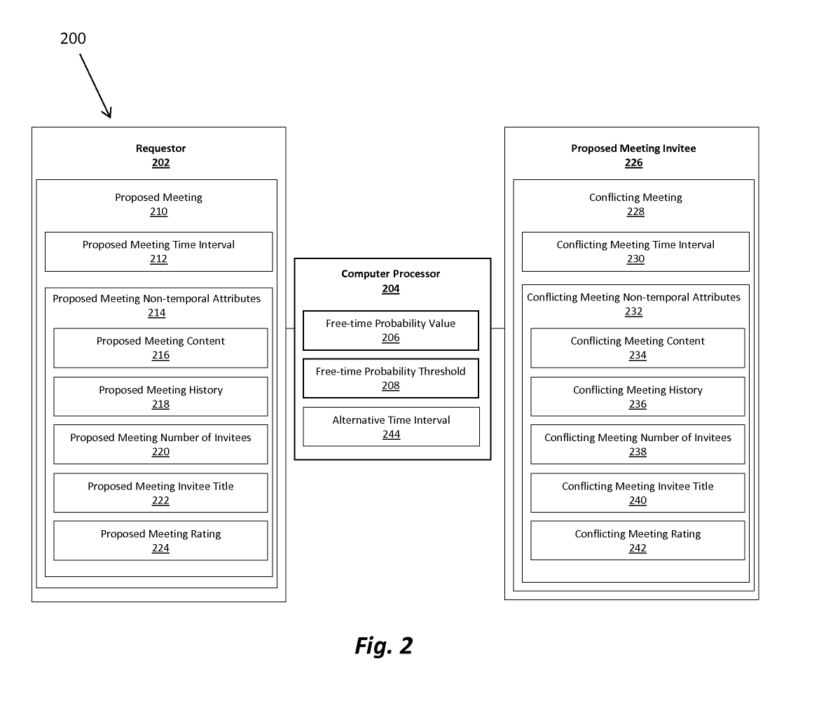

FIG. 2 shows a system for scheduling meeting at conflicting times according to one embodiment of the present invention. The system includes a computer processor 204, at least one meeting requestor 202, and at least one meeting invitee 226.

In one embodiment, the computer processor 204 is configured to receive from the meeting requestor 202 a request to schedule a proposed meeting 210 at a proposed meeting time interval 212. In addition, the computer processor 204 is configured to determine that the proposed meeting time interval 212 intersects with a conflicting meeting time interval 230 of a conflicting meeting 228 in an electronic calendar of at least one proposed meeting invitee 226. Additionally, the computer processor is configured to calculate a free-time probability value 206 for the conflicting meeting 228 based on at least one non-temporal attribute of the conflicting meeting 322 or at least one non-temporal attribute of the proposed meeting 214. The computer processor is further configured to schedule the proposed meeting 210 if the free-time probability value 206 is beyond a free-time probability threshold 208.

In another embodiment, the computer processor 204 is further configured to notify the proposed meeting requestor 202 that the proposed meeting time interval 212 is unavailable if the free-time probability value 206 is within the free-time probability threshold 208.

In another embodiment, the computer processor 204 is further configured to automatically suggest to the proposed meeting requestor 202 at least one alternative time interval in which the proposed meeting may be scheduled 244 if the free-time probability value 206 is within the free-time probability threshold 208. The system may search for a time interval where a free-time probability value of a conflicting meeting exceeds the threshold free-time probability value in order to suggest at least one alternative time interval. For example, if the free-time probability threshold has a value of 0.6, the system may search for a conflicting meeting with a free-time probability value greater than 0.6. If the system identifies a conflicting meeting with a free-time probability value greater than 0.6, the time interval occupied by that conflicting meeting may be suggested to the proposed meeting requestor as an alternative time interval in which the proposed meeting may be scheduled.

In another embodiment, the computer processor 204 is further configured to automatically recommend to the proposed meeting requestor 202 at least one proposed meeting invitee 226 whose exclusion from the proposed meeting would increase the free-time probability value 206 beyond the free-time probability threshold 208. “Exclusion” in this context does not necessarily mean eliminating the at least one proposed meeting invitee from the list of invitees to the proposed meeting. “Exclusion” may mean making the at least one proposed meeting invitee's attendance at the proposed meeting optional. For example, in a case involving multiple proposed meeting invitees with multiple conflicting meetings scheduled on their calendars, the system may suggest that by making a proposed meeting invitee's attendance at the proposed meeting optional as opposed to mandatory, the free-time probability value of the proposed meeting time interval would increase.

In another embodiment, the computer processor 204 is further configured to automatically exclude at least one proposed meeting invitee 226 whose exclusion from the proposed meeting would increase the free-time probability value 206 beyond the free-time probability threshold 208. Again, “exclude” in this context does not necessarily mean eliminating the at least one proposed meeting invitee from the list of invitees to the proposed meeting. “Exclusion” may mean making the at least one proposed meeting invitee's attendance at the proposed meeting optional. For example, in a case involving multiple proposed meeting invitees with multiple conflicting meetings scheduled on their calendars, the system my automatically make a proposed meeting invitee's attendance at the proposed meeting optional as opposed to mandatory in order to increase the free-time probability value of the proposed meeting time interval.

In another embodiment, the at least one non-temporal attribute of the proposed meeting 214 or the conflicting meeting 332 may include proposed meeting content 216, proposed meeting history 218, proposed meeting number of invitees 220, proposed meeting invitee title 222, proposed meeting rating 224, conflicting meeting content 234, conflicting meeting history 236, conflicting meeting number of invitees 238, conflicting meeting invitee title 240, and conflicting meeting rating 242.

Accordingly, in one embodiment of the present invention, a user's calendar may include multiple scheduled meetings of varying importance. For example, a one-on-one meeting with a company vice president may be very important. A very important meeting is not considered to occupy a time interval that is “free” in which to schedule another meeting. However, an unimportant meeting may be considered to occupy a time interval that is “free” in which to schedule another meeting.

According to this embodiment, a computer processor calculates a free-time probability value based on meeting attributes such as: meeting content (e.g., the content of calendar entries); history of meeting schedules as a function of time (e.g., if a meeting with content “A” has always historically been scheduled on top of a meeting with content “B,” then a meeting with content B may be considered to have a high free-time probability); or automated crowd-sourcing of priority (e.g., 5 of 6 group members indicate through tags that a scheduled meeting is important and this probability indication is considered when assessing free-time probability). If this free-time probability value is greater than a threshold value, the time period is considered to be “free” and a proposed meeting may be scheduled over the conflicting meeting.

As used herein, “meeting rating” refers to a rating given to each meeting by that meeting's invitees or third parties indicating how important each invitee or third party considers the meeting to be. As an example of automated crowd-sourcing of priority, when determining free-time probability, other invitees may “rate” the calendar entry (e.g. for a scheduled meeting) using a graphical user interface or by textual input associated with the scheduled meeting. If the ratings from a number of invitees are high (e.g., indicating the meeting is very important to them), then the free-time probability becomes lower (e.g., it would not be wise to schedule another meeting in a particular time-slot, because invitees have placed a great deal of value on the scheduled meeting.) In some embodiments, in addition to invitees, other individuals may be able to rate the meeting to contribute to a crowd sourcing of priority. For example, the managers of invitees may indicate that a meeting is important. The solicitation and receiving of crowd sourcing information may be automated in many fashions. For example, a signal may be automatically sent to meeting invitees to rate the importance of a scheduled meeting, and their responses automatically recorded. This signal may be, for example, in the form of an email, instant message, audio or textual request associated with the calendar entry.

Meetings on a calendar often have different priorities. A low-priority meeting, although scheduled on a user's calendar, may in fact be “free” to be usurped by another request for a meeting at the same time. For example, if the meeting content relates to “cloud computing,” it may have a 0.8 probability of being free during the first half hour. However, if the topic of the meeting is “employee evaluation,” it may have a 0.2 probability of being free. Based on a threshold value, the system may consider the time interval to be free and allow a new meeting to be scheduled on top of all or part of the conflicting meeting. For example, user A may propose a meeting with user B to be scheduled from 2:00-3:00 pm tomorrow. User B's free time probability value for this time period is 0.8. A threshold value, which may be set by the user or some third party, has been set at 0.7. Thus, because the free-time probability value of user B (0.8) is greater than the threshold value (0.7), the time from 2:00-3:00 is considered to be “free” for user B and the meeting is scheduled.

The threshold value may be modified by the user or by a third party as a function of time. Meeting topics may be determined by known methods of topic extraction from text, including latent semantic indexing. A database may be used to map topic to probability values for users, sets of users, employees of a company, etc. This database and these values may be modified by the user, sets of users, managers, family members, etc. Crowd-sourcing may be used to help establish threshold values and free-time probability values. For example, three members of a user's group may declare a meeting to have a high or a low free-time probability indication. This indication can be made by tagging or other means, and this information is automatically considered when determining a free-time probability value.

Note that the number of meeting attendees may be used to obtain an automatic estimate of the free-time probability value corresponding to that meeting. For example, if a meeting has an employee's manager and vice president scheduled along with 10 other employees, the time period corresponding to the meeting may be estimated to have a low free-time probability value. If, in the past, a user has scheduled meetings on top of existing meetings, this information may also be used to estimate meeting importance and free-time probability value. For example, a user may indicate that all meeting entries with the phrase “Cloud Computing” in their titles should be considered by the system to have either high or low free-time probability values.

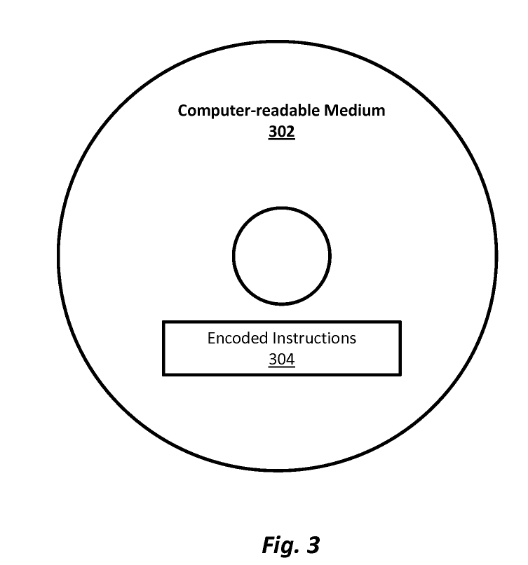

FIG. 3 shows a computer-readable medium 302 encoding instructions for performing a method for scheduling meetings at conflicting times 304 according to one embodiment of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of scheduling meetings at conflicting times, the method comprising:
receiving from a meeting requestor a request to schedule a proposed meeting at a time interval;
determining that the time interval includes a conflicting meeting in an electronic calendar of at least one proposed meeting invitee;
automatically calculating by a computer processor a free-time probability value for the conflicting meeting based on at least one non-temporal attribute of the conflicting meeting or the proposed meeting; and
automatically scheduling the proposed meeting if the free-time probability value is beyond a free-time probability value threshold.

2. The method of claim 1, further comprising:
automatically notifying the proposed meeting requestor that the time interval is unavailable if the free-time probability value is within the free-time probability value threshold.

3. The method of claim 1, further comprising:
automatically suggesting to the proposed meeting requestor at least one alternative time interval in which the proposed meeting may be scheduled if the free-time probability value is within the free-time probability threshold.

4. The method of claim 1, further comprising:
if the free-time probability value is within the free-time probability threshold, automatically recommending to the proposed meeting requestor at least one proposed meeting invitee whose exclusion from the proposed meeting invitees would increase the free-time probability value beyond the free-time probability threshold.

5. The method of claim 1, further comprising:
if the free-time probability value is within the free-time probability threshold, automatically excluding at least one proposed meeting invitee whose exclusion from the proposed meeting invitees increases the free-time probability value beyond the free-time probability threshold.

6. The method of claim 1, wherein the at least one non-temporal attribute of the conflicting meeting or the proposed meeting comprises at least one of proposed meeting content and conflicting meeting content.

7. The method of claim 1, wherein the at least one non-temporal attribute of the conflicting meeting or the proposed meeting comprises at least one of proposed meeting history and conflicting meeting history.

8. The method of claim 1, wherein the at least one non-temporal attribute of the conflicting meeting or the proposed meeting comprises at least one of number of proposed meeting invitees and number of conflicting meeting attendees.

9. The method of claim 1, wherein the at least one non-temporal attribute of the conflicting meeting or the proposed meeting comprises at least one of proposed meeting invitee title and conflicting meeting invitee title.

10. The method of claim 1, wherein the at least one non-temporal attribute of the conflicting meeting or the proposed meeting comprises a proposed meeting rating indicating a combined evaluation of subjective opinions of an importance of the proposed meeting.

11. The method of claim 1, wherein the at least one non-temporal attribute of the conflicting meeting or the proposed meeting comprises a conflicting meeting rating indicating a combined evaluation of subjective opinions of an importance of the conflicting meeting.

12. A system for scheduling meetings at conflicting times, the system comprising:
a computer processor configured to:
receive from a meeting requestor a request to schedule a proposed meeting at a time interval;
determine that the time interval includes a conflicting meeting in an electronic calendar of at least one proposed meeting invitee;
calculate a free-time probability value for the conflicting meeting based on at least one non-temporal attribute of the conflicting meeting or the proposed meeting; and
schedule the proposed meeting if the free-time probability value is beyond a free-time probability value threshold.

13. The system of claim 12, wherein the computer processor is further configured to notify the proposed meeting requestor that the time interval is unavailable if the free-time probability value is within the free-time probability value threshold.

14. The system of claim 12, wherein the computer processor is further configured to automatically suggest to the proposed meeting requestor at least one alternative time interval in which the proposed meeting may be scheduled if the free-time probability value is within the free-time probability threshold.

15. The system of claim 11, wherein the computer processor is further configured to automatically recommend to the proposed meeting requestor at least one proposed meeting invitee whose exclusion from the proposed meeting invitees increases the free-time probability value beyond the free-time probability threshold if the free-time probability value is within the free-time probability threshold.

16. The system of claim 12, wherein the computer processor is further configured to automatically exclude at least one proposed meeting invitee whose exclusion from the proposed meeting invitees would increase the free-time probability value beyond the free-time probability threshold if the free-time probability value is within the free-time probability threshold.

17. The system of claim 12, wherein the at least one non-temporal attribute of the conflicting meeting or the proposed meeting comprises at least one of proposed meeting content, conflicting meeting content, proposed meeting history, conflicting meeting history, number of proposed meeting invitees, number of conflicting meeting attendees, proposed meeting invitee title, and conflicting meeting invitee title.

18. The system of claim 12, wherein the at least one non-temporal attribute of the conflicting meeting or the proposed meeting comprises a proposed meeting rating indicating a combined evaluation of subjective opinions of an importance of the proposed meeting.

19. The system of claim 12, wherein the at least one non-temporal attribute of the conflicting meeting or the proposed meeting comprises a conflicting meeting rating indicating a combined evaluation of subjective opinions of an importance of the conflicting meeting.

20. A computer program product for scheduling meetings at conflicting times, the computer program product comprising:
a computer readable storage medium having computer readable program code embodied therewith, the computer readable program code configured to:
receive from a meeting requestor a request to schedule a proposed meeting at a time interval;
determine that the time interval includes a conflicting meeting in an electronic calendar of at least one proposed meeting invitee;
calculate a free-time probability value for the conflicting meeting based on at least one non-temporal attribute of the conflicting meeting or the proposed meeting; and
schedule the proposed meeting if the free-time probability value is beyond a free-time probability value threshold.

21. The computer program product of claim 20, further comprising:
computer readable program code configured to:
automatically notify the proposed meeting requestor that the time interval is unavailable if the free-time probability value is within the free-time probability value threshold.

22. The computer program product of claim 20, further comprising:
computer readable program code configured to:
notify the proposed meeting requestor that the time interval is unavailable if the free-time probability value is within the free-time probability value threshold.

23. The computer program product of claim 20, further comprising:
computer readable program code configured to:
automatically suggest to the proposed meeting requestor at least one alternative time interval in which the proposed meeting may be scheduled if the free-time probability value is within the free-time probability threshold.

24. The computer program product of claim 20, further comprising:
computer readable program code configured to:
automatically recommend to the proposed meeting requestor at least one proposed meeting invitee whose exclusion from the proposed meeting invitees would increase the free-time probability value beyond the free-time probability threshold if the free-time probability value is within the free-time probability threshold.

25. The computer program product of claim 20, further comprising:
computer readable program code configured to:
automatically exclude at least one proposed meeting invitee whose exclusion from the proposed meeting invitees would increase the free-time probability value beyond the free-time probability threshold if the free-time probability value is within the free-time probability threshold.
